(19) United States
(12) Patent Application Publication
(10) Pub. No.: US 2022/0032214 A1
(43) Pub. Date: Feb. 3, 2022

(54) SUBTERRANEAN GRAVITY-FLOW GRAYWATER FILTRATION APPARATUS AND SYSTEM

(71) Applicant: LeVon Morris, Ventura, CA (US)

(72) Inventor: LeVon Morris, Ventura, CA (US)

(21) Appl. No.: 16/942,578

(22) Filed: Jul. 29, 2020

(51) Int. Cl. B01D 24/20; B01D 24/00; B01D 24/40; B01D 29/05; B01D 29/90; B01D 35/34; B01D 39/16; C02F 1/00

(52) U.S. Cl. CPC B01D 24/205; B01D 24/008; B01D 24/402; B01D 29/05; B01D 29/902; B01D 35/34; C02F 2103/002; C02F 1/001; B01D 2201/04; B01D 2201/301; B01D 2201/48; B01D 2201/29; B01D 39/1623

(57) ABSTRACT

A tank assembly for a gravity-flow graywater filtration system includes a lower portion having a lower-portion sidewall with a port and an upper portion having an extension tank that includes a bottom, an extension-tank sidewall, a removable lid, and an inflow-pipe portion coupled to a first port in the extension-tank sidewall and including a part that extends through a port in the bottom of the extension tank. The tank assembly also includes a filter cartridge housed within the upper portion at a location beneath the extension tank, and a sump pump in the lower portion, the sump pump having an outflow-pipe portion coupled to the port in the lower-portion sidewall.

### TECHNICAL FIELD

The present disclosure relates generally to apparatuses and systems for water reuse, and more particularly, to apparatuses and systems for filtering graywater for reuse as non-potable water.

### BACKGROUND

Graywater filtration systems take water that has already been used from places like a laundry, shower and sink and divert it to use in another purpose like watering gardens or landscaping, instead of diverting it to a sewer line. Graywater is different from blackwater, i.e., sewage, because while graywater may have some residuals like dirt, hair, grease, etc. from its first use, these residuals are not toxic to the environment and the water can be processed and reused in some applications.

### SUMMARY

An aspect of the disclosure relates to a gravity-flow graywater filtration system. The filtration system includes a tank assembly having a lower portion and an upper portion with a top structure, and a filter cartridge located in the upper portion of the tank assembly. The filter cartridge includes a filter-cartridge housing having an open top facing the top structure and a bottom region located and configured to empty water into the lower portion of the tank assembly. A plurality of filter layers extend between the open top of the filter-cartridge housing and the bottom region of the filter-cartridge housing. The plurality of filters include a thermo-plastic mesh layer adjacent the open top, a gravel layer adjacent the bottom region, and a sand layer between the thermo-plastic mesh layer and the gravel layer. The filtration system also includes an inflow pipe located and configured to empty graywater through the open top of the filter-cartridge housing and into the thermo-plastic mesh layer; an outflow pipe located and configured to transport non-potable water from the lower portion of the tank assembly; and a sump pump in the lower portion that is coupled to the outflow pipe and configured to pump non-potable water from the lower portion into the outflow pipe. The top structure of the tank assembly may be an extension tank that is configured to contain a portion of the inflow pipe. The extension tank includes a bottom configured to engage with an upper rim of the upper portion of the tank assembly, an extension-tank sidewall that extends upward relative to the upper rim, and a removable lid. Alternatively, the top structure of the tank assembly may be a removable lid.

Another aspect of the disclosure relates to a tank assembly for a gravity-flow graywater filtration system. The tank assembly includes a lower portion having a sidewall with an outflow port configured to receive an outflow-pipe section, an upper portion contiguous with the lower portion and having a top structure, and a filter cartridge located in the upper portion of the tank assembly. The filter cartridge includes a filter-cartridge housing having an open top facing the top structure and a bottom region located and configured to empty water into the lower portion of the tank assembly. A plurality of filter layers extend between the open top of the filter-cartridge housing and the bottom region of the filter-cartridge housing. The plurality of filters include a thermo-plastic mesh layer adjacent the open top, a gravel layer adjacent the bottom region, and a sand layer between the thermo-plastic mesh layer and the gravel layer. The tank assembly also includes a sump pump in the lower portion that is configured to couple with a first end of the outflow-pipe section.

Another aspect of the disclosure relates to gravity-flow graywater filtration apparatus, that includes a tank assembly and a filter-cartridge housing. The tank assembly is characterized by a first frustoconical form factor and has a lower portion and an upper portion with a top structure that includes at least one inflow port configured to receive an inflow pipe. The filter-cartridge housing includes an open top facing the top structure and a bottom region facing the upper portion, and is characterized by a second frustoconical form factor configured to fit inside the upper portion such that a friction fit between a sidewall of the filter-cartridge housing and a sidewall of the tank assembly removably secures the filter-cartridge housing in the upper portion of the tank assembly.

Another aspect of the disclosure relates to a filter cartridge that includes a housing having an open top configured to receive water and a bottom region including a plurality of perforations. The filter cartridge also includes a plurality of filter layers extending between the open top of the housing and the bottom region of the housing. The plurality of filters include a thermo-plastic mesh layer adjacent the open top, a gravel layer adjacent the bottom, and a sand layer between the thermo-plastic mesh layer and the gravel layer.

It is understood that other aspects of systems and apparatuses will become readily apparent to those skilled in the art from the following detailed description, wherein various aspects of apparatuses and methods are shown and described by way of illustration. As will be realized, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

Various aspects of systems and apparatuses will now be presented in the detailed description by way of example, and not by way of limitation, with reference to the accompanying drawings, wherein:

FIG. 1 is an illustration of a subterranean gravity-flow graywater filtration system including a tank assembly having a top structure in the form of an extension tank, a filter cartridge installed in the tank assembly, and various inflow and outflow pipes.

FIG. 2A is an illustration of the tank assembly of FIG. 1.

FIG. 2B is an illustration of an alternate embodiment of a tank assembly having a top structure in the form of a lid.

FIG. 3 is an illustration of a filter cartridge including a filter-cartridge housing and multistage filter including, from top to bottom, a thermo-plastic mesh layer, a sand layer, and a gravel layer.

FIG. 4 is a schematic cross-section of a filter cartridge relative to a portion of a tank assembly.

### DETAILED DESCRIPTION

Disclosed herein is a gravity-flow graywater filtration system designed to filter domestic or industrial sources of graywater collected from showers, tubs, laundry units and/or other non-toxic or heavily polluted water sources in order to supplement water use. Graywater from appropriate sources is diverted away from a sewer line and into a multistage filter cartridge housed in a tank assembly configured for subterranean installation. The flow of graywater from the appropriate sources into the multistage filter cartridge is by gravity only. No pumps are required in order to transport the graywater to the multistage filter cartridge. In one configuration, the gravity-only flow of graywater is facilitated by a top structure of the tank assembly in the form of an extension tank that enables an increased pitch in the inflow pipe from the graywater sources to the tank assembly and into the filter cartridge. The extension tank may also serve as a barrier between soil, leaves, and other debris and the multistage filter cartridge.

The multistage filter cartridge includes three filter layers, the combination of which removes turbidity and other debris from the graywater. The three filter layers include, in order of gravity flow, a thermo-plastic mesh layer, a sand layer, and a gravel layer. Access to the multistage filter cartridge and filter layers for replacement and maintenance purposes is provided through the top structure of the tank assembly. In one configuration, the top structure is in the form of an extension tank and access to the filter cartridge and its filters may be obtained by removing a lid of the extension tank. In another configuration, the top structure of the tank assembly is in the form of a lid and access to the filter cartridge and its filters may be obtained by removing the lid.

After passing through the multistage filter and completing the filtration process, the water drains into a lower portion of the tank assembly, referred to herein as the “water tank.” A sump pump located in the water tank automatically activates when the filtered graywater reaches a certain level, and pumps the filtered graywater to an outflow port of the tank assembly. The outflow port may be coupled to an outflow pipe, which in turn, may be coupled to a graywater use system. For example, the outflow pipe may be coupled to an irrigation system for landscapes areas. There is no storage of the graywater by the gravity-flow graywater filtration system. Instead, graywater that enters the system is immediately filtered and the filtered graywater is made immediately available for supplementary water use.

Having generally described the gravity-flow graywater filtration system, a more detailed description follows.

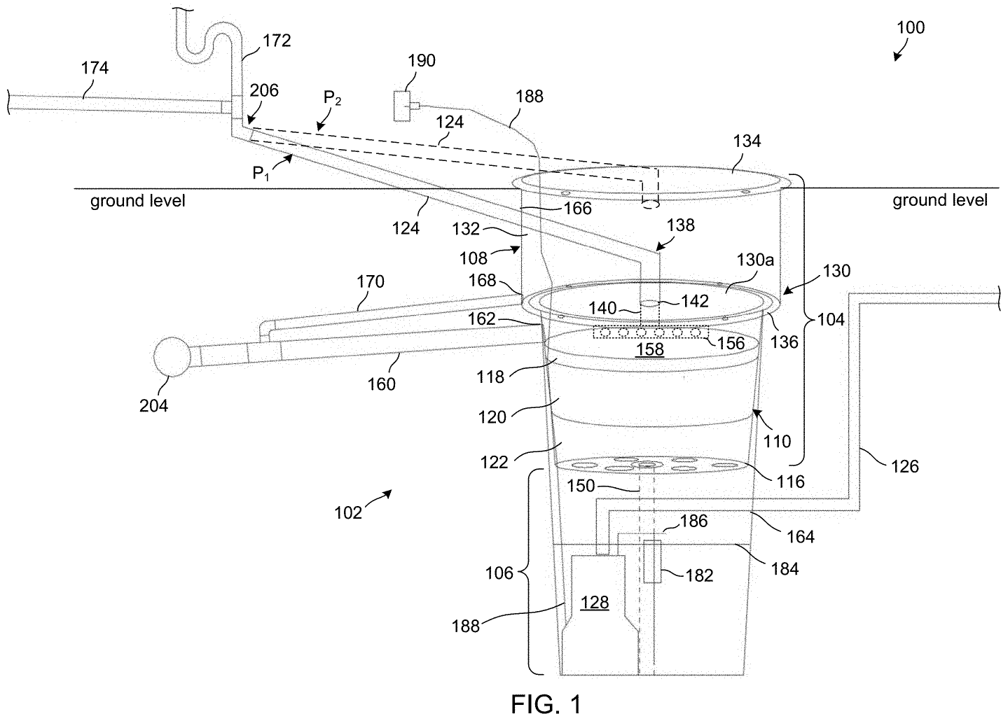

With reference to FIGS. 1, 2A, 2B, and 3, a gravity-flow graywater filtration system 100, includes a tank assembly 102, a filter cartridge 110, an inflow pipe 124, an outflow pipe 126, and a sump pump 128. From a functional perspective, the tank assembly 102 may be divided into an upper portion 104 and a lower portion 106. The upper portion 104 functions to interface with the inflow pipe 124 to receive graywater and to house the filter cartridge 110. The lower portion 106 of the tank assembly 102 functions to receive filtered graywater from the filter cartridge 110. The lower portion 106 of the tank assembly 102 may be referred to as a “water tank” or “water basin.”

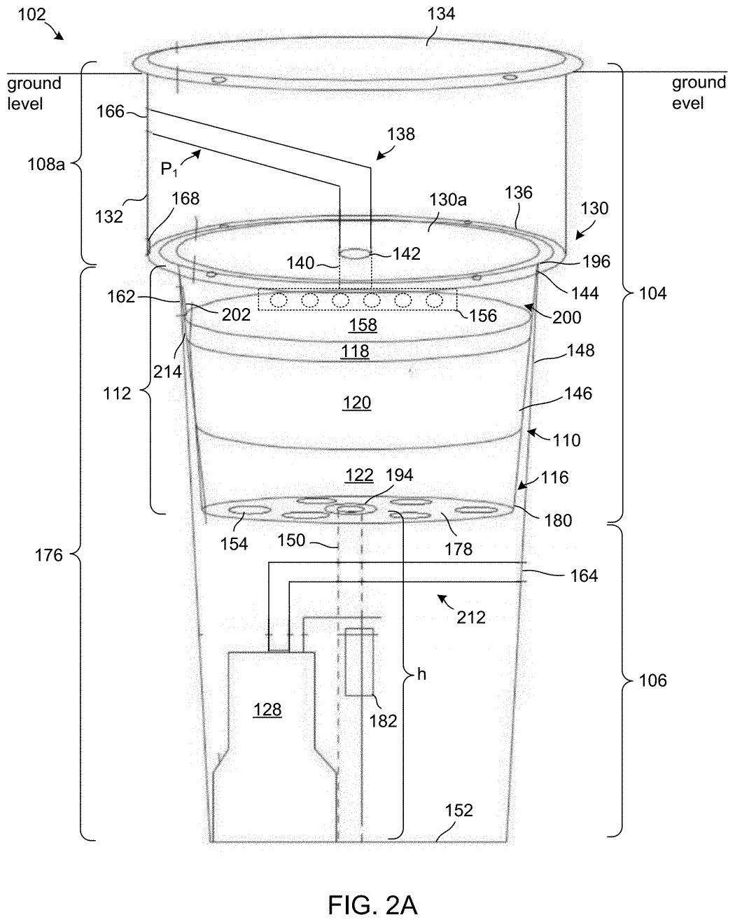

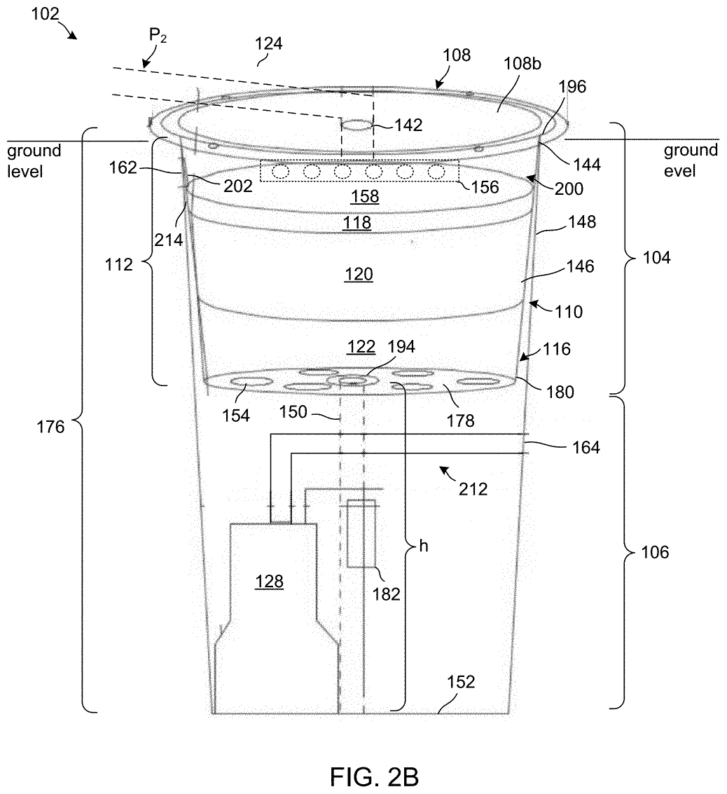

The upper portion 104 of the tank assembly 102 includes a top structure 108. With reference to FIG. 2A, in one embodiment of the tank assembly 102, the top structure 108 is an extension tank 108a, also referred to as an “extension basin.” The extension tank 108a includes a bottom 130 that is configured to engage with an upper rim 136 of the upper portion 104 of the tank assembly 102, an extension-tank sidewall 132 that extends upward relative to the upper rim of the tank assembly, and a removable lid 134. A portion 138 of the inflow pipe 124 is contained within the interior of the extension tank 108a. In one configuration, the bottom 130 of the extension tank 108a is open to allow for easy access to the interior of the filter cartridge 110 through removal of the lid 134.

In another configuration, the bottom 130 of the extension tank 108a is a panel structure 130a that forms a barrier between the interior of the extension tank and the interior of the filter cartridge 110. A part 140 of the inflow pipe 124 extends through a port 142 in the panel structure 130a. The panel structure 130a rests at the bottom of the extension tank 108a and may be secured in place by a mechanical structure, such as a tab or screw. The panel structure 130a may be formed of a solid semi-rigid, flexible, plastic sheet or a wire mesh that allows for upward displacement of the panel structure from the bottom of the extension tank 108a to provide access to the interior of the filter cartridge 110.

With reference to FIG. 2B, in another embodiment of the tank assembly 102, the top structure 108 may be a lid 108b. Access to the interior of the filter cartridge 110 is obtained through removal of the lid 108b.

A top structure 108 in the form of an extension tank 108a, as opposed to a lid 108b, is advantageous for several reasons. First, an extension tank 108a allows for placement of the filter cartridge 110 of the system 100 at a deeper subterranean level, which in turn provides for an increase in the downward slope or pitch of the inlet pipe 124 relative to the graywater source point 206. For example, with reference to FIGS. 1, 2A and 2B, in comparing the downward slope P1 of the inflow pipe 124 when an extension tank 108a is present (as shown in FIGS. 1 and 2A), with the downward slope P2 of the inflow pipe 124 (dashed lines) without an extension tank (as shown in FIGS. 1 and 2B), it is noted that an extension tank 108a provides for a greater pitch P1. The increased pitch from the graywater source point 206 increases the efficiency of delivery by gravity alone and thereby eliminates the need for additional power, equipment, and maintenance because a pump is not needed to move the graywater into the filtration system.

A second advantage of the extension tank 108a, particularly an extension tank having a panel structure 130a at the bottom, is the elimination of the inflow of debris into the filter cartridge 110 that may occur when the tank assembly 102 is installed with the filter cartridge 110 closer to ground level. The extension tank 108a is positioned to capture any sediment, leaves, etc. that may inadvertently enter the tank assembly 102 through the tank lid 134. The extension tank 108a captures this sediment, and thereby prevents the debris from clogging or being trapped in the filter cartridge 110, which increases the filtration quality and longevity of the filter cartridge.

With reference to FIGS. 2A and 2B, from a structural perspective, the tank assembly 102 may include two structures, a base tank 176 and the top structure 108, either in the form of an extension tank 108a (FIG. 2A) or a lid 108b (FIG. 2B). In either embodiment, the base tank 176 may be, for example, a 30″ (height) by 18″ (diameter) sump basin with a 30 gallon capacity made of polyethylene structural foam (PSF), polyethylene or fiberglass. In the extension tank embodiment of FIG. 2A, the extension tank 108a may be, for example, a 6″ or 12″ or 18″ (height) by 18″ diameter tank composed of PSF. The extension tank 108a may be adjoined to the base tank 176 by inserting a foam gasket and securing with screws.

In either embodiment, the filter cartridge 110 is located in the upper portion 104 of the tank assembly 102 and includes a filter-cartridge housing 112 and a plurality of filter layers 118, 120, 122 placed inside the filter-cartridge housing. The filter-cartridge housing 112 has an open top 114 facing the top structure 108 and a bottom region 116 located and configured to empty water into the lower portion 106 of the tank assembly 102. To this end, the bottom region 116 of the filter cartridge 110 includes perforations 154 through which the water empties into the lower portion 106 of the tank assembly 102. The perforations 154 may be formed through a bottom panel 178 of the filter-cartridge housing 112. Alternatively, or in combination, the perforations may be formed at spaced-apart locations around a bottom perimeter 180 of the filter-cartridge housing 112 and through the sidewall of the filter-cartridge housing 112.

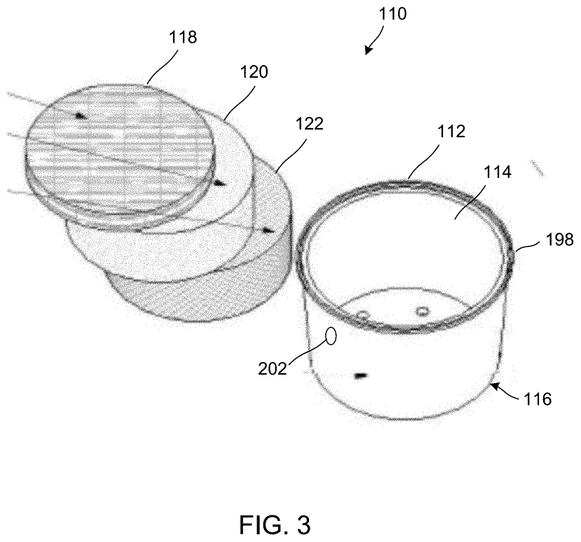

With reference to FIG. 3, the filter layers 118, 120, 122 extend between the open top 114 of the filter-cartridge housing 112 and the bottom region 116 of the filter-cartridge housing. The plurality of filters include a thermo-plastic mesh layer 118 adjacent the open top 114, a gravel layer 122 adjacent the bottom region 116, and a sand layer 120 between the thermo-plastic mesh layer and the gravel layer. The total height of the layers 118, 120, 122 places the top surface of the thermo-plastic mesh layer 118 at a level beneath the top rim of the filter-cartridge housing 112. Thus, the filter cartridge 110 includes an empty space 200 or gap located above the thermo-plastic mesh layer 118.

As describe further below, the different layers 118, 120, 122 have different physical characteristics and structures. Generally, however, the thickness of the thermo-plastic mesh layer 118 is approximately one-half the thickness of the sand layer 120 and the gravel layer 122. The filter cartridge 110 does not include a biological filter. Thus, the filtered graywater is non-potable.

The thermo-plastic mesh layer 118 may be made of a curly fiber thermo-polypropylene compound (TPPC) or thermo-polyethylene compound (TPEC) formed into layers and shapes of different thicknesses. The formula of the TPPC or TPEC and the thickness of the fiber used determines the structure of the filter media, its specific surface, and its density and thickness. In one configuration, the thermo-plastic mesh layer 118 is a thermo-polypropylene compound with fibers that range in diameter from 0.0197-0.0748 inch and densities between 92-94% free volume. The thermo-plastic mesh layer 118, which may range in thickness between 1.5-4.5 inches, functions to capture larger particulate matter, like hair, which may clog or reduce the filtration ability of the sand layer 120 and gravel layer 122 filters. The thermo-plastic mesh layer 118 may be removed and cleaned for repeated use by accessing the filter cartridge 110 through the top structure 108 of the tank assembly 102.

In one configuration, the sand layer 120 comprises 0.45-0.055 mm diameter sand that is graded silicone quartz. The sand is retained in a 50 micron mesh bag. The sand layer 120, which may range in thickness between 2-6 inches, functions to capture soaps and detergents. The sand layer 120 is easily removed and cleaned for repeated use or removed and replaced by accessing the filter cartridge 110 through the top structure 108 of the tank assembly 102.

In one configuration, the gravel layer 122 comprises 2-4 mm diameter gravel. The gravel is retained in a mesh bag with a mesh size of 1 mm. The gravel layer 122, which may range in thickness between 2-6 inches, functions as a drainage area for the filtered graywater, as well as provide a course filtration of water and particulate matter that may have bypassed the initial stage filters. For example, soapy residue may accumulate and adhere to the gravel. The gravel layer 122 is easily removed and cleaned for repeated use or replaced by accessing the filter cartridge 110 through the top structure 108 of the tank assembly 102.

It is noted that the order of the filter layers 118, 120, 122 in the direction of the gravity flow of graywater through the filter cartridge 110 is from a fine filter with smaller particle sizes, e.g., the thermo-plastic mesh layer 118 with 0.0197-0.0748 inch and densities between 92-94% free volume, to a less fine filter with smaller particle sizes, e.g., the sand layer 120 with 0.45-0.055 mm diameter sand, to a coarse filter with larger particle sizes, e.g., the gravel layer 122 with 2-4 mm diameter gravel. This order is distinct from known gravity-flow filters that arrange filters in the opposite manner, i.e., from coarse filter to fine filter, and is beneficial in that it traps large sediment upon initial filtration through the thermo-plastic layer, and the sand layer 120 is not compacted by the weight of a layer, e.g., gravel layer, above it, and thus provides a more permeable layer for filtration. Compaction of the sand layer 120 can decrease the filtration capacity by decreasing the porosity of the sand layer. Additionally, the force of the water through the inflow pipe 160 provides agitation of the sand layer 120, further helping to prevent compaction and which allows for better drainage over time.

With reference to FIG. 1, the inflow pipe 124 is located and configured to empty graywater through the open top 114 of the filter-cartridge housing 112 and into the thermo-plastic mesh layer 118. The inflow pipe 124 may be coupled to one or more sources of graywater. For example, with reference to FIG. 1, the inflow pipe 124 may be coupled to a first graywater-source pipe 172 from a shower/bath, and a second graywater-source pipe 174 from a laundry.

The outflow pipe 126 is located and configured to transport non-potable water from the lower portion 106 of the tank assembly 102 to other locations for use. For example, the outflow pipe 126 may provide filtered graywater to an irrigation system for watering plants. The outflow pipe 126 extends through an outflow port 164 through the sidewall 148 of the tank assembly 102 in the area of the lower portion 106 of the tank assembly. To this end, with reference to FIGS. 2A and 2B, in one configuration, the portion 212 of the outflow pipe 126 inside the tank assembly is coupled to the sump pump 128 at one and to the outflow port 164 at the other end. The outflow port 164 includes a pipe coupling having a gasket to ensure a watertight seal. With reference to FIG. 1, the pipe coupling is configured to couple to the portion of the outflow pipe 126 that is outside the tank assembly 102. In another configuration, the part of the outflow pipe 126 that extends through the sidewall 148 in the area of the lower portion 106 of the tank assembly 102 may be a single, contiguous piece of pipe that fits through an outlet port 164 that is in the form of a hole with a gasket and fitting that ensure a watertight seal.

The sump pump 128 is located in the lower portion 106 of the tank assembly 102 and is coupled to the outflow pipe 126. The sump pump 128 is configured to pump non-potable water from the lower portion 106 of the tank assembly 102 into the outflow pipe 126. To this end, a float switch 182 associated with the sump pump 128 floats at or near the water level 184 in the lower portion 106 of the tank assembly 102. Similar in function to a conventional toilet float activation switch (although in reverse), the float switch 182 automatically activates the sump pump 128 when water reaches a designated height, and deactivates the sump pump when the float switch has descended to the lowest position. The sump pump 128 is powered through a power cord 188 that extends upward through the tank assembly 102, through a gasket in the lid 134 of the extension tank 108a, to an above ground power outlet 190.

The size of the base tank 176 and the sump pump 128 may be determined by volume of inflow and irrigation/landscape design. In one example, the base tank 176 may be a 30″ by 18″ sump basin with a 30 gallon capacity, and the sump pump 128 may be a ¾ HP stainless steel 110V submersible sump pump with an estimated 5245 gallons per hour (GPH) capacity at 5 feet vertical head.

Continuing with FIGS. 1 and 2A, as previously described, a top structure 108 in the form of an extension tank 108a includes a bottom 130, an extension-tank sidewall 132, and a removable lid 134. The bottom 130 is configured to engage with an upper rim 136 of the upper portion 104 of the tank assembly 102. For example, the bottom 130 may be secured to the upper rim 136 by screws securing the extension tank 108a to the base tank 176.

A portion 138 of the inflow pipe 124 is contained within the interior of the extension tank 108a. To this end, the extension-tank sidewall 132 includes a first port 166 configured to receive the inflow pipe 124. The first port 166 may include a pipe coupling having a gasket to ensure a watertight seal. With reference to FIG. 1, the pipe coupling is configured to couple to the portion of the inflow pipe 124 that is outside the extension tank 108a. In another configuration, the part of the inflow pipe 124 that extends through the sidewall of the extension tank 108a may be a single, contiguous piece of pipe that fits through an first port 166 that is in the form of a hole with a gasket and fitting that ensure a watertight seal.

In one configuration, the bottom 130 of the extension tank 108a is open and faces the open top of the filter cartridge 110. In another configuration, the bottom 130 of the extension tank 108a is a panel structure 130a that forms a barrier between the interior of the extension tank and the interior of the filter cartridge 110. In this configuration, a part 140 of the inflow pipe 124 extends through a port 142 in the panel structure 130a. Also, in this configuration, the extension-tank sidewall 132 may also include a second port 168 configured to couple to a flush line 170 that couples to an overflow pipe 160 for purposes of flushing out sediment captured by the panel structure 130a. The second port 168 may include a pipe coupling having a gasket to ensure a watertight seal. With reference to FIG. 1, the pipe coupling is configured to couple to the flush line 170.

With reference to FIG. 2B, as previously described, a top structure 108 may be in the form of lid 108b that is configured to engage with an upper rim 136 of the upper portion 104 of the tank assembly 102. For example, the lid 108b may be secured to the upper rim 136 by screws. In this configuration, a part 140 of the inflow pipe 124 extends through a port 142 in the lid 108b to face the open top of the filter cartridge 110.

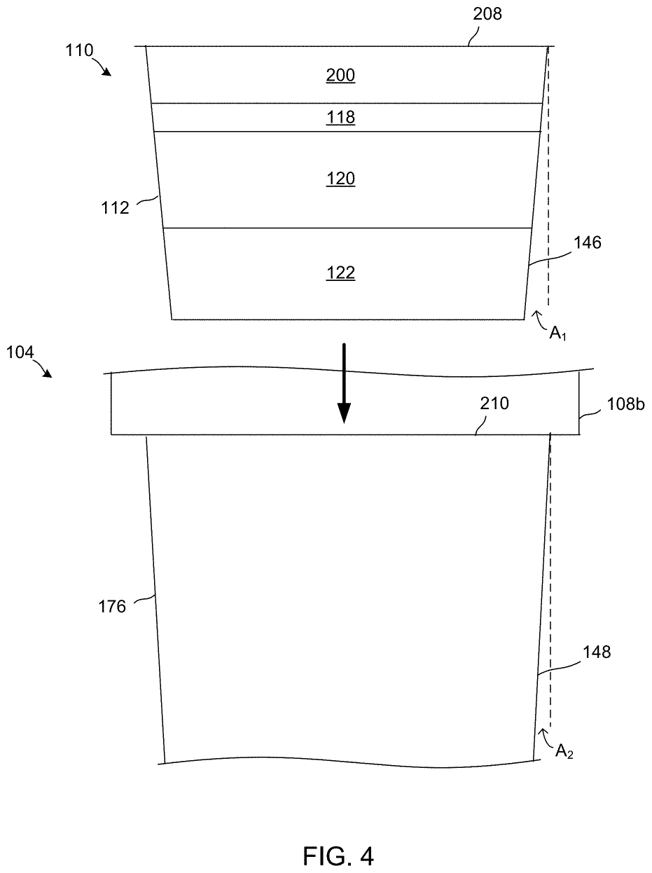

With reference to FIGS. 1, 2A, 2B, and 4, the filter cartridge 110 may be secured in place in the upper portion of the tank assembly 102 in any one of several ways. In one embodiment, the upper portion 104 of the tank assembly 102 may be characterized by a first frustoconical form factor and the filter-cartridge housing 112 may be characterized by a second frustoconical form factor configured to fit inside the upper portion 104 such that a friction fit 144 between a sidewall 146 of the filter-cartridge housing and the sidewall 148 of the upper portion 104 of the tank assembly 102 removably secures the filter-cartridge housing in the upper portion of the tank assembly. The respective frustoconical form factors may have different angles at which their respective sidewalls taper. Considering FIG. 4, for example, the taper angle A₁ between the filter-cartridge sidewall 146 and its top horizontal 208 is greater than the taper angle A₂ between the sidewall 148 in the upper portion 106 of the tank assembly 102 and its top horizontal 210.

In another embodiment, a support leg 150 extends upward from the bottom 152 of the tank assembly 102 to a height h that enables the support leg to support the bottom region 116 of the filter-cartridge housing 112. In this configuration, the bottom panel 178 of the filter-cartridge housing 112 may include a mechanical structure 194, e.g., recess or protrusion, that mates with a structure at the top of the support leg 150.

With reference to FIGS. 2A, 2B, and 3, in another embodiment, the upper portion 104 of the tank assembly 102 includes a tank rim 196 for supporting a filter-housing rim 198 of the filter-cartridge housing 112. A rubber gasket (not shown) associated with the tank rim 196 provides a seal between the interior of the filter cartridge 110 and the external environment.

With reference to FIGS. 1, 2A, 2B, and 3, the inflow pipe 124 includes a distributor portion 156 positioned over the open top 114 of the filter-cartridge housing 112. The distributor portion 156 is configured to separate a single flow of water through the inflow pipe 124 into a number of separate flows spaced apart relative to an upper surface 158 of the thermo-plastic mesh layer 118 of the filter cartridge 110. To this end, the distributor portion 156 may comprise a linear or arcuate portion of pipe spanning above the upper surface 158 and having a number of holes formed through for graywater to pass.

With reference to FIGS. 1, 2A, and 2B, the gravity-flow graywater filtration system 100 further includes an overflow pipe 160 having a downstream end coupled to a sewer or septic line 204, and an upstream end in fluid communication with the empty space 200 located above the thermo-plastic mesh layer 118. Such fluid communication may be provided through a first overflow port 162 of the tank assembly 102 that is configured to receive the overflow pipe 160. The first overflow port 162 may include a pipe coupling having a gasket to ensure a watertight seal. In another configuration, the overflow pipe 160 may simply extend through a first overflow port 166 that is in the form of a hole with a gasket and fitting that ensure a watertight seal. In either case, the end of the overflow pipe 160 may terminate into a gap 214 between the sidewall 146 of the filter-cartridge housing 112 and the sidewall 148 in the area of the upper portion 106 of the tank assembly 102, with fluid communication between the overflow pipe and the empty space 200 being provided by one or more openings or spaces (not shown) between the upper perimeter of the filter-cartridge housing 112 and the inner surface of the sidewall 148 in the area of the upper portion 106 of the tank assembly 102, in the area of the friction fit 144. Alternatively, the overflow pipe 160 may also extend through a second overflow port 202 of the filter-cartridge housing 112 that is aligned with the first overflow port 162 to thereby place the end of the overflow pipe 160 directly in the empty space 200.

With reference to FIG. 1, during operation of the gravity-flow graywater filtration system 100, graywater from a source pipe 172, 174 flows through the inflow pipe 124 and into the tank assembly 102, where is it fed into the filter cartridge 110. The graywater passes through the thermo-plastic mesh layer 118, the sand layer 120 and the gravel layer 122. The filtered graywater exits the bottom region 16 of the filter cartridge 110 and falls into the lower portion 106 of the tank assembly 102.

Graywater collects in the lower portion 106 of the tank assembly 102 until the water level 184 causes the switch 182 to turn on the sump pump 128. When turned on, the sump pump 128 pumps the filtered graywater from the lower portion 106 of the tank assembly 102 into the outflow pipe 126. The sump pump 128 continues to pump until the water level within the lower portion 106 has decreased to a minimum level as indicated by the sump pump float switch 182. Thus, graywater is not stored in the tank assembly 102.

In cases where the sump pump 128 fails to operate, a rising level of graywater in the lower portion 106 of the tank assembly 102 may cause graywater being filtered to back up: 1) into the gap 214 between the sidewall 146 of the filter-cartridge housing 112 and the sidewall 148 toward the upper perimeter of the filter-cartridge housing 112, and/or 2) through the bottom region 116 of the filter cartridge 110 toward the inflow pipe 124. In the case of water backing up into the gap 214, such backed up water is diverted out of the tank assembly 102 through the overflow pipe 160 and into the sewer or septic line 204. In the case of water backing up into the filter cartridge 112, such backed up water enters and begins to fill the empty space 200 above the thermo-plastic mesh layer 118, and is diverted out of the tank assembly 102 through the overflow pipe 160 and into the sewer or septic line 204. Similarly, in cases where water flow through the filter cartridge 110 becomes blocked, graywater coming into the filter cartridge fills the empty space 200 above the thermo-plastic mesh layer 118, and is diverted out of the tank assembly 102 through the overflow pipe 160 and into the sewer or septic line 204. In either case, the arrangement of the outflow pipe 160 relative to the filter cartridge 110 provide for the redirection of graywater to the existing sewer or septic line 204. This redirection prevents the graywater from backing up into the inflow line 124 where it may come into contact with freshwater systems or city/county water supply lines.

The gravity-flow graywater filtration system 100 is maintained through periodic cleaning and replacement of one or more layers 118, 120, 122 of the filter cartridge 110, and flushing of the extension tank 108a, as well as the periodic maintenance of the sump pump 128 and cleaning of the lower portion 106. To these ends, the filter cartridge 110 is a top-loading filter that allows for access to the layers 118, 120, 122 by removing the either the lid 134 of an extension tank 108a or the lid 108b of the base tank 176. In cases where the extension tank 108a includes a bottom panel structure 130a, the interior of the extension tank 108a may be accessed by removing the lid 134 and any sediment captured therein may be flushed with water through the flush line 170 and into the overflow pipe 160.

Thus disclosed is a gravity-flow graywater filtration system that filters graywater from bathroom sinks, shower/tub and/or washing machine to provide non-potable water for other uses, such as landscape irrigation. The filtration system includes a sealed tank assembly with top entry for subterranean or above ground installation in an exterior environment, which provides easy access and flexible location to be placed near a source of graywater.

The various aspects of this disclosure are provided to enable one of ordinary skill in the art to practice the present invention. Various modifications to exemplary embodiments presented throughout this disclosure will be readily apparent to those skilled in the art. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A gravity-flow graywater filtration system, comprising:
a tank assembly having a lower portion and an upper portion with a top structure;
a filter cartridge located in the upper portion of the tank assembly and comprising:
a filter-cartridge housing having an open top facing the top structure and a bottom region located and configured to empty water into the lower portion of the tank assembly, and
a plurality of filter layers extending between the open top of the filter-cartridge housing and the bottom region of the filter-cartridge housing, the plurality of filters comprising a thermo-plastic mesh layer adjacent the open top, a gravel layer adjacent the bottom region, and a sand layer between the thermo-plastic mesh layer and the gravel layer;
an inflow pipe located and configured to empty graywater through the open top of the filter-cartridge housing and into the thermo-plastic mesh layer;
an outflow pipe located and configured to transport non-potable water from the lower portion of the tank assembly; and
a sump pump in the lower portion and coupled to the outflow pipe and configured to pump non-potable water from the lower portion into the outflow pipe.

2. The filtration system of claim 1, wherein the top structure comprises an extension tank comprising:
a bottom configured to engage with an upper rim of the upper portion of the tank assembly;
an extension-tank sidewall that extends upward relative to the upper rim; and
a removable lid,
wherein the extension tank is configured to contain a portion of the inflow pipe.

3. The filtration system of claim 2, wherein the bottom of the extension tank is open.

4. The filtration system of claim 2, wherein the bottom of the extension tank comprises a panel structure that forms a barrier between an interior of the extension tank and an interior of the filter cartridge, and a part of the inflow pipe extends through a port in the panel structure.

5. The filtration system of claim 2, wherein the extension-tank sidewall comprises a first port configured to receive the inflow pipe.

6. The filtration system of claim 2, wherein the extension-tank sidewall comprises a second port configured to couple to a flush line that couples to an overflow pipe.

7. The filtration system of claim 1, wherein the top structure comprises a removable lid.

8. The filtration system of claim 1, wherein the upper portion of the tank assembly is characterized by a first frustoconical form factor and the filter-cartridge housing is characterized by a second frustoconical form factor configured to fit inside the upper portion such that a friction fit between a sidewall of the filter-cartridge housing and a sidewall of the upper portion removably secures the filter-cartridge housing in the upper portion of the tank assembly.

9. The filtration system of claim 1, wherein the tank assembly further comprises a support leg extending upward from a bottom of the tank assembly to a height h that enables the support leg to support the bottom region of the filter-cartridge housing.

10. The filtration system of claim 1, wherein a thickness of the thermo-plastic mesh layer is approximately one-half a thickness of the sand layer and the gravel layer.

11. The filtration system of claim 1, wherein the bottom region of the filter cartridge is configured to empty water into the lower portion of the tank assembly through a plurality of perforations formed in the filter-cartridge housing.

12. The filtration system of claim 1, wherein:
the inflow pipe comprises a distributor portion aligned with the open top of the filter-cartridge housing, and
the distributor portion is configured to separate a single flow of water through the inflow pipe into a plurality of separate flows spaced apart relative to an upper surface of the thermo-plastic mesh layer of the filter cartridge.

13. The filtration system of claim 1, further comprising an overflow pipe in fluid communication with an open interior space of the filter cartridge.

14. The filtration system of claim 1, wherein the outflow pipe extends through an outflow port through a sidewall of the lower portion of the tank assembly.

15. A tank assembly for a gravity-flow graywater filtration system, the tank assembly comprising:
a lower portion having a sidewall with an outflow port configured to receive an outflow-pipe section;
an upper portion contiguous with the lower portion and having a top structure;
a filter cartridge located in the upper portion of the tank assembly and comprising:
a filter-cartridge housing having an open top facing the top structure and a bottom region located and configured to empty water into the lower portion of the tank assembly, and
a plurality of filter layers extending between the open top of the filter-cartridge housing and the bottom region of the filter-cartridge housing, the plurality of filters comprising a thermo-plastic mesh layer adjacent the open top, a gravel layer adjacent the bottom region, and a sand layer between the thermo-plastic mesh layer and the gravel layer; and
a sump pump in the lower portion configured to couple with a first end of the outflow-pipe section.

16. The tank assembly of claim 15, wherein the top structure comprises an extension tank comprising:
a bottom configured to engage with an upper rim of the upper portion of the tank assembly;
an extension-tank sidewall that extends upward relative to the upper rim; and
a removable lid,
wherein the extension tank is configured to contain a portion of an inflow pipe.

17. The tank assembly of claim 16, wherein the bottom of the extension tank is open.

18. The tank assembly of claim 16, wherein the bottom of the extension tank comprises a panel structure that forms a barrier between an interior of the extension tank and an interior of the filter cartridge, and a part of the inflow pipe extends through a port in the panel structure.

19. The tank assembly of claim 15, wherein the top structure comprises a removable lid.

20. A gravity-flow graywater filtration apparatus, comprising:
a tank assembly characterized by a first frustoconical form factor and having a lower portion and an upper portion with a top structure comprising at least one inflow port configured to receive an inflow pipe; and
a filter-cartridge housing comprising an open top facing the top structure and a bottom region facing the upper portion, and characterized by a second frustoconical form factor configured to fit inside the upper portion such that a friction fit between a sidewall of the filter-cartridge housing and a sidewall of the tank assembly removably secures the filter-cartridge housing in the upper portion of the tank assembly.
